(19) United States
(12) Patent Application Publication
(10) Pub. No.: US 2011/0115820 A1
(43) Pub. Date: May 19, 2011

(54) INFORMATION PROCESSING APPARATUS, INFORMATION PROCESSING METHOD, AND PROGRAM

(76) Inventors: SHUNICHI KASAHARA, KANAGAWA (JP); TOMOYA NARITA, KANAGAWA (JP)

(21) Appl. No.: 12/938,980

(22) Filed: Nov. 3, 2010

(30) Foreign Application Priority Data
Nov. 16, 2009 (JP) P2009-261283

(51) Int. Cl. G09G 5/00

(52) U.S. Cl. 345/650; 345/676; 345/661

(57) ABSTRACT

An information processing apparatus includes a detection unit configured to detect an operation input in a predetermined operation direction, and a display control unit configured to display, on a display unit, first auxiliary information indicating the predetermined operation direction and second auxiliary information indicating a movement direction of display information with respect to the display unit, and to move the display information while moving the first auxiliary information in the movement direction in accordance with the operation input detected by the detection unit and moving the second auxiliary information in association with the movement of the first auxiliary information.

### BACKGROUND OF THE INVENTION

1. Field of the Invention

The present invention relates to an information processing apparatus, an information processing method, and a program which facilitate movement of an object displayed on a display unit in accordance with a movement of an operating member.

2. Description of the Related Art

In recent years, user interfaces (UIs) that include touch panels to allow anyone to easily input and output information have increasingly become popular. For example, a user can make a gesture to directly drag a screen with an operating member such as a finger to scroll the screen so that an operational process associated with the gesture can be executed (see, for example, Japanese Unexamined Patent Application Publication No. 2009-205675). By associating a gesture with an intuitive operational process that can be easily imagined by a user from the gesture, the user can easily perform an input operation using the gesture.

### SUMMARY OF THE INVENTION

However, because of the configuration of a device operated by a user, there is a limitation on the number of gestures that can be recognized by the device, and operational processes and gestures may not necessarily be associated in a one-to-one correspondence. For example, an operating member may operate only in one direction. In this case, in order to move the operating member in a plurality of directions such as up, down, left, and right, a plurality of operation areas corresponding to the operation directions may be provided. If the plurality of operation areas are provided, the operating member may be frequently moved to move display information, resulting in reduced operability.

Further, if the movement direction of the operating member is different from the movement direction of the display information, it may be difficult for the user to intuitively understand the operation. Moreover, if the amount of movement of the display information is different from the amount of operation of the operating member, position adjustment of the display information, such as moving the display information a large amount or fine adjustment of the position of the display information, may be difficult.

It is therefore desirable to provide a novel and improved information processing apparatus, information processing method, and program which enable intuitive presentation of the association between the movement direction of an operating member and the movement direction of display information.

According to an embodiment of the present invention, an information processing apparatus includes a detection unit configured to detect an operation input in a predetermined operation direction; and a display control unit configured to display, on a display unit, first auxiliary information indicating the predetermined operation direction and second auxiliary information indicating a movement direction of display information with respect to the display unit, and to move the display information while moving the first auxiliary information in the movement direction in accordance with the operation input detected by the detection unit and moving the second auxiliary information in association with the movement of the first auxiliary information.

According to an embodiment of the present invention, when the display range of display information displayed on a display unit is moved, a display control unit allows the display of auxiliary information indicating the movement direction of an operating member used to move the display information and auxiliary information indicating the movement direction of the display information. In this case, first auxiliary information and second auxiliary information are displayed so as to operate in association with each other. This can give a user a visual presentation of the association between the operation direction and the movement direction of the display information in easily understandable form. Thus, operability can be improved.

Here, the display information may be movable in a plurality of directions with respect to the display unit, and the display control unit may be configured to change the movement direction of the display information and an indication of the second auxiliary information indicating the movement direction of the display information, in accordance with a pressing operation input detected by the detection unit.

Further, when the detection unit detects a pressing operation input and a moving operation input, the display control unit may be configured to enlarge or reduce the display information in accordance with a magnitude of the pressing operation input detected by the detection unit.

In addition, when the detection unit detects a pressing operation input and a moving operation input, the display control unit may be configured to move the display information in a depth direction in accordance with a magnitude of the pressing operation input detected by the detection unit, and to display second auxiliary information indicating the depth direction.

The display control unit may also be configured to change an amount of movement of the display information in accordance with a magnitude of a pressing operation input detected by the detection unit.

Each of the first auxiliary information and the second auxiliary information may be a gear graphic that is a graphical representation of a gear. The display control unit may be configured to move the display information in accordance with an operation input detected by the detection unit, and may also be configured to move a first gear graphic indicating the operation direction in the operation direction, and to display a second gear graphic configured to mesh with the first gear graphic, indicating the movement direction of the display information with respect to the display unit, in association with the movement of the first gear graphic.

The display control unit may also be configured to change a gear ratio of gear graphics displayed as the first auxiliary information and the second auxiliary information, in accordance with a ratio of an amount of movement of an operating member used to perform an operation input to an amount of movement of the display information.

The display control unit may also be configured to display the first auxiliary information and the second auxiliary information in a peripheral area of the display unit.

The display control unit may also be configured to display on the display unit third auxiliary information indicating a ratio and position of a display range displayed within a display area of the display unit to an overall size of the display information.

Another embodiment of the present invention provides an information processing method including the steps of detecting an operation input in a predetermined operation direction; displaying on displaying means first auxiliary information indicating the operation direction and second auxiliary information indicating a movement direction of display information with respect to the displaying means; and moving the display information while moving the first auxiliary information in the movement direction in accordance with the detected operation input and moving the second auxiliary information in association with the movement of the first auxiliary information.

Another embodiment of the present invention provides a computer program for causing a computer to function as the information processing apparatus described above. The computer program may be stored in a storage device included in the computer, and may be read and executed by a central processing unit (CPU) included in the computer. Thus, the computer may be caused to function as the information processing apparatus described above. Further, a computer-readable recording medium having the computer program recorded thereon may also be provided. Examples of the recording medium include a magnetic disk and an optical disk.

According to an embodiment of the present invention, therefore, an information processing apparatus, an information processing method, and a program which enable intuitive presentation of the association between the movement direction of an operating member and the movement direction of display information can be provided.

### BRIEF DESCRIPTION OF THE DRAWINGS

FIG. 1 is a diagram illustrating an image capture apparatus including an information processing apparatus according to a first embodiment of the present invention;

FIG. 2 is a diagram illustrating an example of display of auxiliary information in the image capture apparatus including the information processing apparatus according to the first embodiment;

FIG. 3 is a diagram illustrating another example of display of auxiliary information in the image capture apparatus including the information processing apparatus according to the first embodiment;

FIG. 4 is a block diagram illustrating a hardware configuration of the information processing apparatus according to the first embodiment;

FIG. 5 is a diagram illustrating an example configuration of a display device and a sensor unit of the information processing apparatus according to the first embodiment;

FIG. 6 is a diagram illustrating another example configuration of the display device and the sensor unit of the information processing apparatus according to the first embodiment;

FIG. 7 is a block diagram illustrating a functional configuration of the information processing apparatus according to the first embodiment;

FIG. 8 is a flowchart illustrating a display control process of the information processing apparatus according to the first embodiment;

FIG. 9 is a diagram illustrating an example of display of auxiliary information indicating the association between the movement direction of an operating member and the movement direction of display information;

FIG. 10 is a diagram illustrating an example of switching of the display of auxiliary information;

FIG. 11 is a diagram illustrating an example of a wheel graphic displayed as auxiliary information;

FIG. 12 is a diagram illustrating an example of display of auxiliary information indicating the movement speed of content using the function of a variable speed gear;

FIG. 13 is a diagram illustrating a display example in which auxiliary information indicating the display range of content is further displayed in a graphic that is a representation of auxiliary information;

FIG. 14 is a diagram illustrating a process for enlarging or reducing content using an information processing apparatus according to a fourth embodiment of the present invention;

FIG. 15 is a diagram illustrating an example in which the display control process performed by an information processing apparatus according to first to fourth embodiments is applied to the operation of a web browser;

FIG. 16 is a diagram illustrating an example in which the display control process performed by an information processing apparatus according to the first to fourth embodiments is applied to the operation of a map viewer;

FIG. 17 is a diagram illustrating an example of display of auxiliary information indicating movement in the depth direction when a content list in which a plurality of content items are arranged in the depth direction is operated; and

FIG. 18 is a diagram illustrating a display example in which the display magnification of display information is represented using auxiliary information extending in the depth direction.

### DESCRIPTION OF THE PREFERRED EMBODIMENTS

Exemplary embodiments of the present invention will be described in detail with reference to the accompanying drawings. In the specification and the drawings, elements having substantially the same functions and configurations are given the same reference symbols, and thus redundant descriptions will be omitted.

The description will be given in the following order:

1. First embodiment (the configuration of an information processing apparatus configured to display auxiliary information and display control performed by the information processing apparatus)

2. Second embodiment (an example of display of auxiliary information: conversion from the rotational direction into the linear direction)

3. Third embodiment (an example of display of auxiliary information: auxiliary information indicating the display range and position of display information)

4. Fourth embodiment (enlargement and reduction of display information)

5. Fifth embodiment (an example of display of auxiliary information: movement in the depth direction)

### First Embodiment

### Example Configuration of Image Capture Apparatus Including Information Processing Apparatus

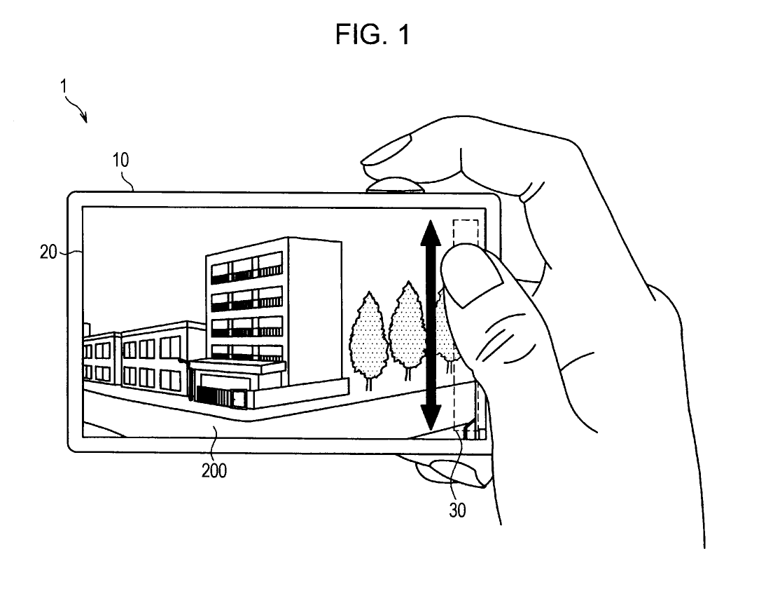

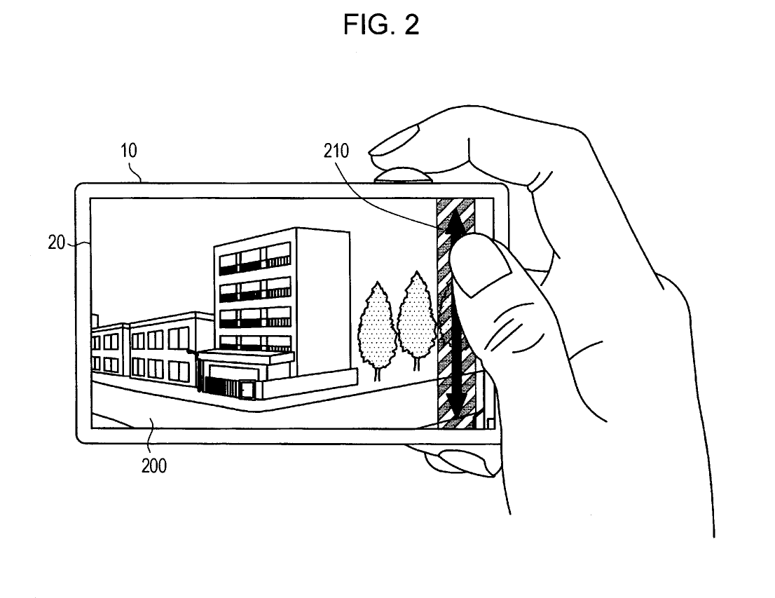

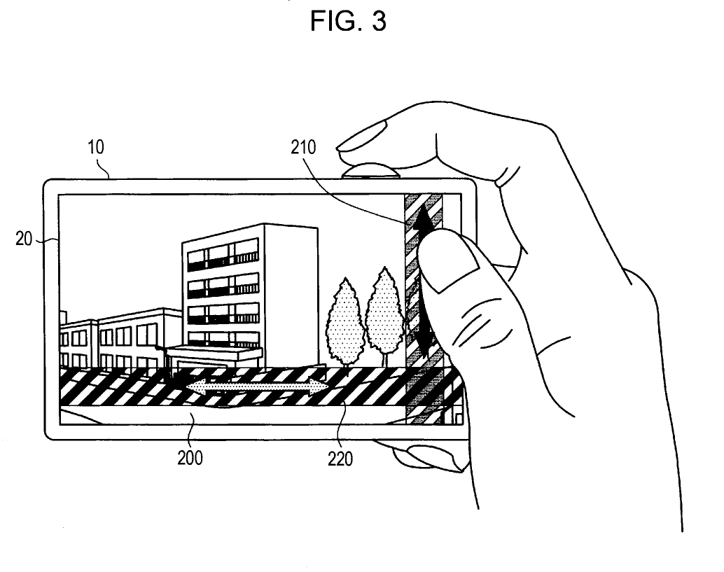

First, an example configuration of an image capture apparatus including an information processing apparatus according to a first embodiment of the present invention will be described with reference to the FIGS. 1 to 3. FIG. 1 illustrates an image capture apparatus 1 including an information processing apparatus according to this embodiment. FIGS. 2 and 3 illustrate an example of display of auxiliary information about the image capture apparatus 1 including the information processing apparatus according to this embodiment.

The information processing apparatus according to this embodiment provides a visual representation of the movement direction of display information that moves in accordance with an operation input made by an operating member, and can be provided in, for example, the image capture apparatus 1 illustrated in FIG. 1. The image capture apparatus 1 according to this embodiment includes a display 20 on the rear surface of a housing 10, which is configured to display an image obtained using an imaging element through a lens provided on the front surface of the housing 10. The image capture apparatus 1 further has an operation area 30 along an edge of the display 20 or in a side portion of the display 20. The operation area 30 includes a touch sensor and a pressure sensor serving as a detection unit configured to detect an input of operation information. In the operation area 30 according to this embodiment, only one operation direction (for example, up-down direction) can be detected.

When the entirety of an obtained image is not displayed on the display 20, a user can move the display range of the image displayed on the display 20 by moving their finger in the operation area 30. For example, as illustrated in FIG. 1, when a user holds the image capture apparatus 1 with one hand, the user may move the display range of the display 20 by moving their finger within the operation area 30 while viewing the image displayed on the display 20.

Because of the configuration of the operation area 30, the display range of the image is moved in accordance with the movement of the finger in the up-down direction. The movement in the right-left direction of the image in addition to the movement in the up-down direction is performed by the same operation. For ease of understanding of the association between the movement direction of the finger and the movement direction of the display range of the screen, the information processing apparatus according to this embodiment displays graphics as illustrated in FIGS. 2 and 3 as auxiliary information.

For example, if the movement direction of the finger is the same as the movement direction of the display range of the image, as illustrated in FIG. 2, a graphic 210 extending substantially parallel to the movement direction of the finger is displayed on the display 20. If the movement direction of the finger is different from the movement direction of the display range of the image, as illustrated in FIG. 3, a graphic 220 that extends substantially parallel to the movement direction of the display range of the image and that operates in association with the graphic 210 extending substantially parallel to the movement direction of the finger is displayed on the display 20. The graphics 210 and 220 are representations of mechanisms for physical conversion of the direction of movement, which is displayed on the display 20, and may be implemented using, for example, as illustrated in FIGS. 2 and 3, graphical representations of gears. The graphics displayed as auxiliary information give a user a visual presentation of the movement direction of the display range of the image, leading to improved operability. In the following, the configuration and process of the above information processing apparatus will be described in detail.

### Hardware Configuration of Information Processing Apparatus

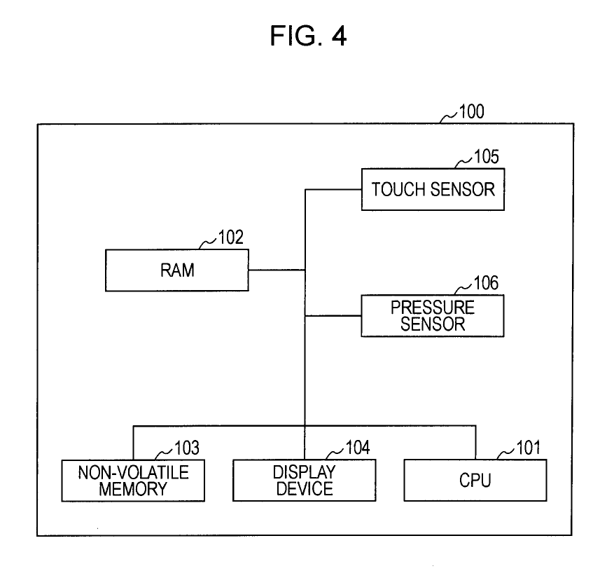

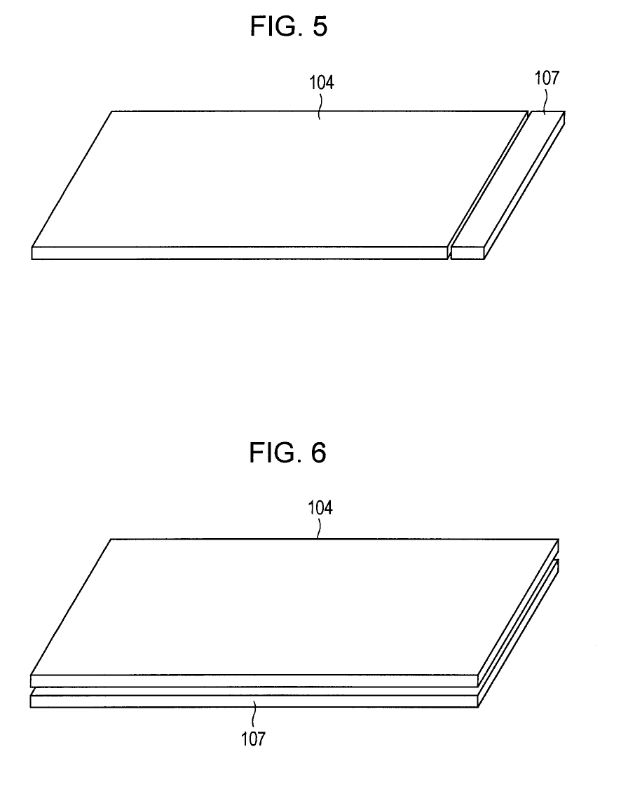

First, the hardware configuration of an information processing apparatus 100 according to this embodiment will be described with reference to FIGS. 4 to 6. FIG. 4 is a block diagram illustrating the hardware configuration of the information processing apparatus 100 according to this embodiment. FIGS. 5 and 6 are diagrams illustrating an example configuration of a display device 104 and a sensor unit 107 of the information processing apparatus 100 according to this embodiment.

As illustrated in FIG. 4, the information processing apparatus 100 according to this embodiment includes a central processing unit (CPU) 101, a random access memory (RAM) 102, and a non-volatile memory 103. The information processing apparatus 100 further includes the display device 104, a touch sensor 105, and a pressure sensor 106.

The CPU 101 serves as an arithmetic processing device and a control device, and controls the overall operation of the information processing apparatus 100 in accordance with various programs. The CPU 101 may be a microprocessor. The RAM 102 temporarily stores a program used in the execution by the CPU 101, parameters that change appropriately during the execution of the program, and other suitable data. The CPU 101 and the RAM 102 are connected to each other via a host bus formed of a CPU bus or the like. The non-volatile memory 103 stores a program used by the CPU 101, calculation parameters, and other suitable data. The non-volatile memory 103 may be implemented using, for example, a read only memory (ROM) or a flash memory.

The display device 104 may be an example of an output device that outputs information. Examples of the display device 104 include a cathode ray tube (CRT) display device, a liquid crystal display (LCD) device, and an organic light emitting diode (OLED) device. In this embodiment, the display 20 of the image capture apparatus 1 illustrated in FIG. 1 may be used.

The touch sensor 105 may be an example of an input device that allows a user to input information, and includes an input unit configured to input information and an input control circuit configured to generate an input signal based on a user input and to output the input signal to the CPU 101. A user can operate the touch sensor 105 to input various data to the information processing apparatus 100 or to instruct the information processing apparatus 100 to perform a processing operation. The pressure sensor 106 may be a sensor configured to detect pressure force applied by the user with the operating member. The pressure sensor 106 converts the detected pressure force into an electrical signal, and outputs the electrical signal as a detection result.

The touch sensor 105 and the pressure sensor 106 of the information processing apparatus 100 according to this embodiment form the sensor unit 107 configured to detect an input of operation information for moving display information. The sensor unit 107 including the touch sensor 105 and the pressure sensor 106 may be provided in, for example, as illustrated in FIG. 5, a side portion of the display device 104 separately from the display device 104, or may be stacked on the display device 104 in a manner as illustrated in FIG. 6. When the display device 104 and the sensor unit 107 are stacked on each other, as illustrated in FIG. 6, the sensor unit 107 may be provided over an entire display area of the display device 104. Alternatively, the sensor unit 107 may be provided only in the operation area 30 where an operation input is performed.

### Functional Configuration of Information Processing Apparatus

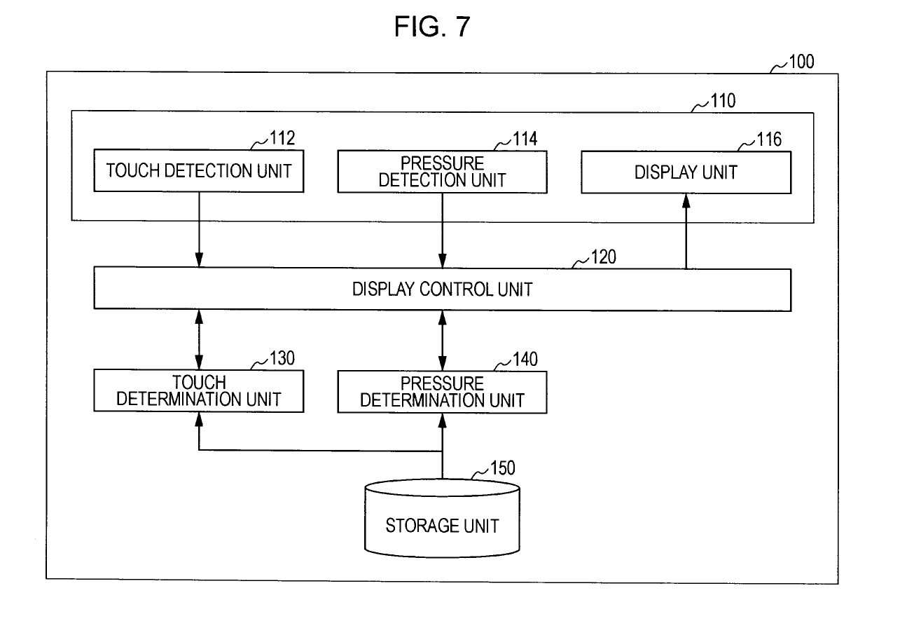

Next, the functional configuration of the information processing apparatus 100 according to this embodiment will be described with reference to FIG. 7. FIG. 7 is a block diagram illustrating the functional configuration of the information processing apparatus 100 according to this embodiment. As illustrated in FIG. 7, the information processing apparatus 100 according to this embodiment includes an input display unit 110, a display control unit 120, a touch determination unit 130, a pressure determination unit 140, and a storage unit 150.

The input display unit 110 may be a functional unit configured to display information and to input information, and includes a touch detection unit 112, a pressure detection unit 114, and a display unit 116. The touch detection unit 112 may correspond to the touch sensor 105 illustrated in FIG. 4, and detects an electrostatic capacitance value that changes depending on whether or not the operating member has touched the operation area where the sensor unit 107 is provided. When the operating member touches the display surface, the electrostatic capacitance value detected by the touch detection unit 112 increases. Thus, when the electrostatic capacitance value detected by the touch detection unit 112 exceeds a predetermined value, it can be determined that the operating member has touched the display surface. The touch detection unit 112 outputs the detected electrostatic capacitance value to the display control unit 120 as a detection result.

The pressure detection unit 114 may correspond to the pressure sensor 106 illustrated in FIG. 4, and detects a pressure applied to the operation area with the operating member. The pressure detection unit 114 outputs an electrical signal corresponding to the magnitude of the pressure to the display control unit 120 as a detection result. The display unit 116 may be an output device corresponding to the display device 104 illustrated in FIG. 4, and displays information subjected to display processing by the display control unit 120. For example, display information including content, an image, text, and a map and auxiliary information indicating the operation state are displayed on the display unit 116.

The display control unit 120 may be a control unit that controls the display of display information and auxiliary information to be displayed on the display unit 116 in accordance with the detection results input from the touch detection unit 112 and the pressure detection unit 114. The display control unit 120 outputs the electrostatic capacitance value input from the touch detection unit 112 to the touch determination unit 130, and causes the touch determination unit 130 to determine whether or not the operating member has touched the display surface of the display unit 116. Upon receipt of a determination result of the touch determination unit 130, the display control unit 120 starts a process for moving the display information displayed on the display unit 116 and displaying the auxiliary information in accordance with the determination result. Further, the display control unit 120 calculates the amount and speed of movement of the operating member from the touch position of the operating member recognized by the touch determination unit 130, and changes the display of the display information and the auxiliary information in accordance with the calculated information.

Further, the display control unit 120 outputs the electrical signal representing the magnitude of the pressure, which has been input from the pressure detection unit 114, to the pressure determination unit 140 to cause the pressure determination unit 140 to determine the magnitude of the pressure generated through the operation of the operating member or the amount of change of the pressure. Upon receipt of the determination result from the pressure determination unit 140, the display control unit 120 starts a process for moving the display information displayed on the display unit 116 and displaying the auxiliary information in accordance with the determination result. Then, the display control unit 120 causes the display unit 116 to display the display information and auxiliary information subjected to display processing.

The touch determination unit 130 determines whether or not the operating member has touched the display surface of the display unit 116 and also determines the touch position based on the detection result of the touch detection unit 112. When the electrostatic capacitance values detected by electrostatic sensors in the touch detection unit 112 are input from the display control unit 120, the touch determination unit 130 determines whether or not the operating member has touched the display surface of the display unit 116. When the amount of increase of the electrostatic capacitance exceeds a predetermined value, the touch determination unit 130 determines that the operating member has touched the display surface. Further, the touch determination unit 130 can also recognize the touch position of the operating member on the display surface from the position of an electrostatic sensor that has detected an electrostatic capacitance equal to or greater than the predetermined value. The touch determination unit 130 outputs the determination result indicating whether or not the operating member has touched the display surface, and, if it is determined that the operating member has touched the display surface, the touch position of the operating member to the display control unit 120.

The pressure determination unit 140 determines the magnitude of the pressure applied to the display surface with the operating member in accordance with the detection result of the pressure detection unit 114. In the information processing apparatus 100 according to this embodiment, a user can change the magnitude of pressure to apply to the display surface, thereby switching the movement direction of display information, enlarging/reducing the display information, switching the movement speed of the display information, and performing other processing. The pressure determination unit 140 determines the magnitude of the pressure to be applied to the operation area or the amount of change of the pressure. In this case, the pressure determination unit 140 compares the magnitude of the pressure applied to the operation area with various pressure threshold values by referring to the storage unit 150, and outputs a comparison result to the display control unit 120.

The storage unit 150 may correspond to the non-volatile memory 103 illustrated in FIG. 4, and stores various setting information that is used to determine the degree of magnitude of pressure applied to the operation area. Examples of the setting information include the pressure by which the movement direction of the display information is switched, the movement speed of the display information, which is set in accordance with the movement speed of the operating member, and the relationship between the magnitude of pressure and the enlargement/reduction ratio of the display information.

### Display Control by Information Processing Apparatus

With the use of the information processing apparatus 100 described above, when the touch, press, or movement of the operating member within the operation area is detected, the display information displayed on the display unit 116 is moved or enlarged/reduced in accordance with the detected operation. In addition, during the process for moving the display information, the information processing apparatus 100 displays auxiliary information indicating the association between the movement direction of the operating member and the movement direction of the display information.

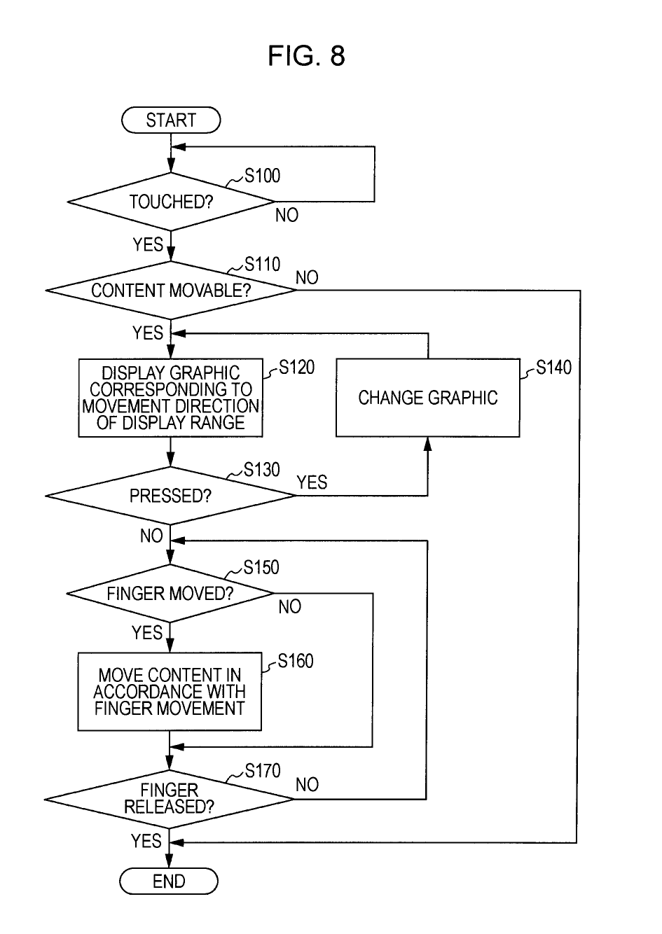

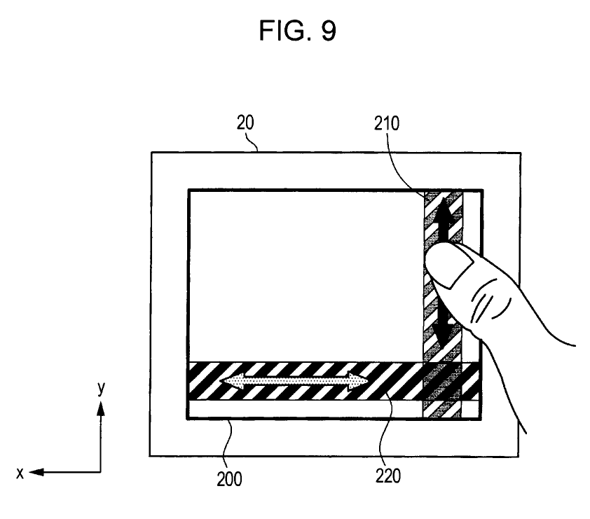

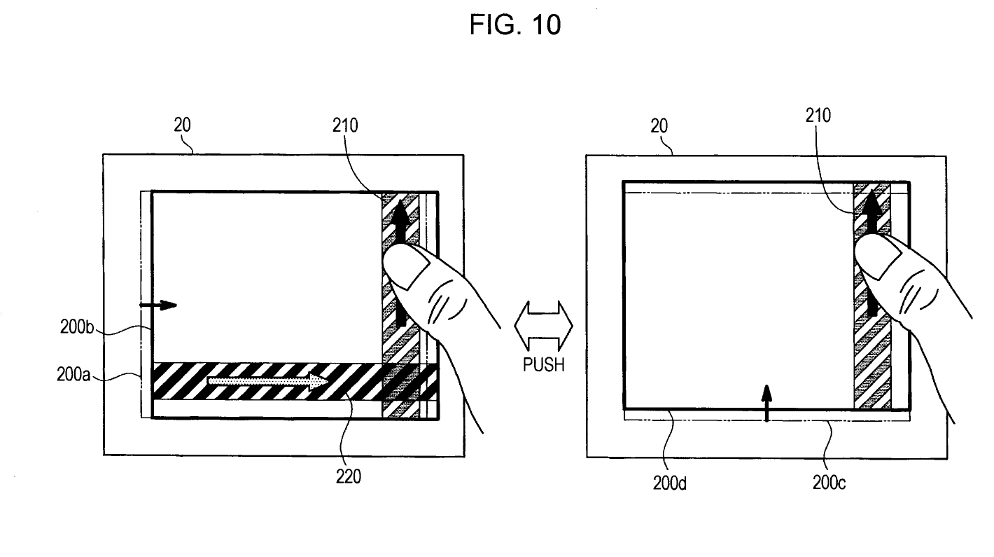

Hereinafter, display control performed by the information processing apparatus 100 according to this embodiment will be described with reference to FIGS. 8 to 10. FIG. 8 is a flowchart illustrating a display control process of the information processing apparatus 100 according to this embodiment. FIG. 9 illustrates an example of display of auxiliary information indicating the association between the movement direction of the operating member and the movement direction of the display information. FIG. 10 illustrates an example of switching of the display of the auxiliary information. In the following description, it is assumed that the operating member is the user's finger and that the display information is content.

The display control process performed by the information processing apparatus 100 according to this embodiment is started when a start operation for starting the process is detected. Examples of the start operation include touching (contacting) the operation area with the operating member such as the user's finger. In this case, in the information processing apparatus 100, the touch determination unit 130 determines whether or not the operating member has touched the operation area in accordance with the detection result of the touch detection unit 112 (step S100). If it is determined that the operating member has not touched the operation area, the information processing apparatus 100 repeats the processing of step S100. If it is determined that the operating member has touched the operation area, on the other hand, the information processing apparatus 100 determines whether or not content, which is display information, is movable within the display area of the display unit 116 (step S110).

The state where content is movable is as follows. For example, in some cases, the display size of content may be too large with respect to the display area to display the content within the display area. In such cases, a user can confirm even a portion of the content displayed outside the display area by moving the display range of the content. Other examples of the state where content is movable include moving a pointer or the like by moving the operating member within the operation area. The display control unit 120 of the information processing apparatus 100 determines whether or not the content is movable. If the content is not movable, the process ends. If the content is movable, a graphic corresponding to the movement direction of the display range of the content is displayed as auxiliary information (step S120).

Here, the operation area of the image capture apparatus 1 including the information processing apparatus 100 according to this embodiment can detect only one direction of movement of the operating member. However, the display range of the content may be moved in only one direction or in multiple directions. If the movement direction of the operating member and the movement direction of the content match, the user can easily recognize the operation of the operating member in an intuitive manner and can easily perform the operation. If the content is moved in a direction different from the direction in which the user actually moves the operating member, however, it may be difficult to recognize the operation of the operating member in an intuitive manner, and operability may be reduced. Therefore, the information processing apparatus 100 according to this embodiment displays auxiliary information on the display unit 116 for assisting understanding of the relationship between the movement direction of the operating member and the movement direction of the content.

The auxiliary information may be a graphical representation of a mechanism for physical conversion of the direction of movement. For example, as illustrated in FIG. 9, it is assumed that content 200 is displayed on the display 20 of the image capture apparatus 1. In this case, it is assumed that the movement direction that can be detected using the operation area is only one direction, the y-axis direction, and that the content 200 is movable in two directions, the x-axis direction and the y-axis direction. When a user is moving their finger in the y-axis direction within the operation area, the information processing apparatus 100 displays a gear graphic 210 extending substantially parallel to the movement direction of the finger. As the finger moves in the y-axis direction, the graphic 210 is displayed so as to move in the positive or negative y-axis direction in accordance with the movement direction of the finger.

When the content 200 is moved in the x-axis direction, on the other hand, the information processing apparatus 100 displays a gear graphic 220 intersecting the gear graphic 210 extending substantially parallel to the x-axis direction. The gear graphic 220 is displayed in such a manner that the teeth of the gear graphic 220 mesh with the teeth of the gear graphic 210 at intersecting positions. When the user moves their finger in the y-axis direction within the operation area, the information processing apparatus 100 displays the gear graphic 210 whose movement direction matches the movement direction of the finger so that the gear graphic 210 moves in the movement direction of the finger. In addition, the information processing apparatus 100 displays the gear graphic 220 in such a manner that the teeth of the gear graphic 220 move in engagement with the teeth of the gear graphic 210. In this manner, the graphic 220 is displayed so as to mechanically move in association with the movement of the graphic 210 to allow the user to visually observe the conversion of the movement direction of the finger into the movement direction of the content. This can reduce unnatural feeling during the operation caused by the difference between the movement direction of the finger and the movement direction of the content.

When the touch determination unit 130 determines, based on the detection result of the touch detection unit 112, that the finger has touched the operation area and when the display range of the content 200 displayed on the display unit 116 is movable, the display control unit 120 of the information processing apparatus 100 displays the graphic 210 in a side portion within the display area in substantially parallel to the movement direction of the finger. For example, when a substantially rectangular display area as illustrated in FIG. 9 is provided, the graphic 210 is displayed along a side near the operation area among the sides of the display area that are substantially parallel to the y-axis direction. In this manner, since the auxiliary information is displayed in a side portion of the display area, the display information displayed behind the auxiliary information is not prevented from being displayed. Further, the color of the graphics 210 and 220 displayed as auxiliary information may be matched with the color of the content 200 which is display information so that the content 200 can be prevented from being displayed.

Then, in this state, the information processing apparatus 100 recognizes the relationship between the movement direction of the content 200 and the movement direction of the finger. When the movement directions are different from each other, the graphic 220 extending substantially parallel to the movement direction of the content 200 is displayed in another side portion of the display area. For example, in a case where a substantially rectangular display area as illustrated in FIG. 9 is used, the display control unit 120 of the information processing apparatus 100 displays the graphic 220 in a lower area of the display area so as to extent substantially parallel to the x-axis direction. In this case, the graphics 210 and 220 are displayed so as to intersect each other in such a manner that the teeth of the gears represented by the graphics 210 and 220 mesh each other.

When the user moves their finger within the operation area in a state where the graphics 210 and 220 are displayed, the gear graphic 210 moves in the same direction as the movement direction of the finger. Further, when the graphic 220 is being displayed, the graphic 220 is displayed so as to move in association with the movement of the graphic 210.

Next, the display control unit 120 of the information processing apparatus 100 determines whether or not the operation area has been pushed with the finger (step S130). In the image capture apparatus 1 including the information processing apparatus 100 according to this embodiment, as described above, a user is allowed to input an operation in only one direction within the operation area. However, switching the movement direction of the content 200 allows the display range of the content 200 to be moved in multiple directions. In this embodiment, the movement direction of the content 200 may be switched through the operation of pushing the operation area with the finger. Embodiments of the present invention are not limited to this example, and, for example, another operation within the operation area may be performed to switch the movement direction of the content 200. A separate switching button may be provided, and pressing the button may cause switching of the movement direction of the content 200.

The pressure determination unit 140 of the information processing apparatus 100 determines, based on the detection result of the pressure detection unit 114, whether or not the pressure force of the finger becomes greater than or equal to a predetermined pressure threshold value and then becomes less than the predetermined pressure threshold value, thereby determining whether or not the operation area has been pushed. If it is determined that the operation area has been pushed, the display control unit 120 changes the movement direction of the content 200, and displays, together with the graphic 210, a graphic extending substantially parallel to the changed movement direction of the content 200 (step S140).

For example, as illustrated in the right screen in FIG. 10, in a state where only the graphic 210 extending substantially parallel to the movement direction of the finger (that is, in the direction in which an operation within the operation area can be input) is displayed, the content 200 moves in the direction in which the graphic 210 extends, which is substantially the same as the movement direction of the finger. Thus, for example, if the finger moves in the upward direction, the position of the content 200 moves from a position 200c to a position 200d. If the operation area is pushed with the finger, the movement direction of the content 200 is changed from the up-down direction to the right-left direction. As illustrated in the left screen in FIG. 10, the graphic 220 extending substantially parallel to the right-left direction is displayed. Then, when the user moves their finger in the upward direction, the position of the content 200 moves from a position 200a to a position 200b. In this case, the graphic 220 is displayed so as to move in association with the graphic 210 that is displayed so as to move in accordance with the movement of the finger.

In this manner, switching the movement direction of the content 200 enables the content 200 to be moved in multiple directions even in a case where an operation in only one direction within the operation area can be input. In the example of FIG. 10, it is possible to switch between the movement in the up-down direction and the movement in the right-left direction of the content 200 each time the operation area is pushed with the finger, and auxiliary information (in this embodiment, the gear graphics 210 and 220) is displayed accordingly.

As long as the movement direction of the content 200 is not switched, it is determined whether or not the finger has moved within the operation area (step S150). If the finger has moved, the graphics 210 and 220 are displayed so as to move in accordance with the movement of the finger, and the display range of the content 200 is moved (step S160). If the finger does not move, no movement of the content 200 is made. Then, the touch determination unit 130 determines, based on the detection result of the touch detection unit 112, whether or not the finger has been released from the operation area (step S170). If it is determined that the finger has been released, the process ends. If the finger is still in contact with the operation area, the process returns to step S150, and the process is repeatedly performed until the finger is released from the operation area.

The display control process performed by the information processing apparatus 100 according to the first embodiment of the present invention has been described. According to the information processing apparatus 100, auxiliary information indicating the association between the direction in which the operating member is operated and the movement direction of display information is displayed in accordance with the direction in which the display information can be moved. This allows a user to visually check the movement direction of the display information, thus improving operability.

### Second Embodiment

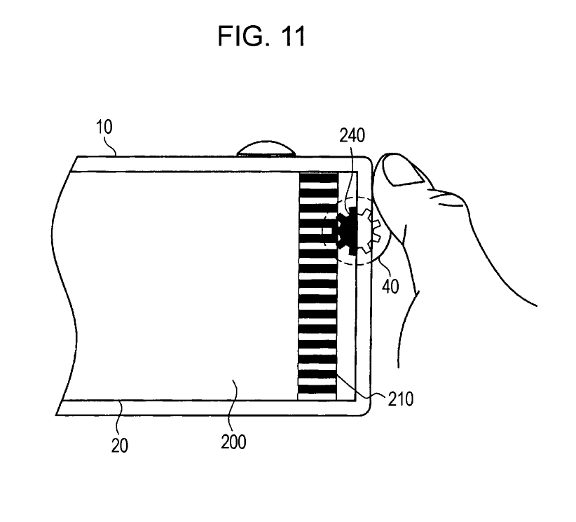

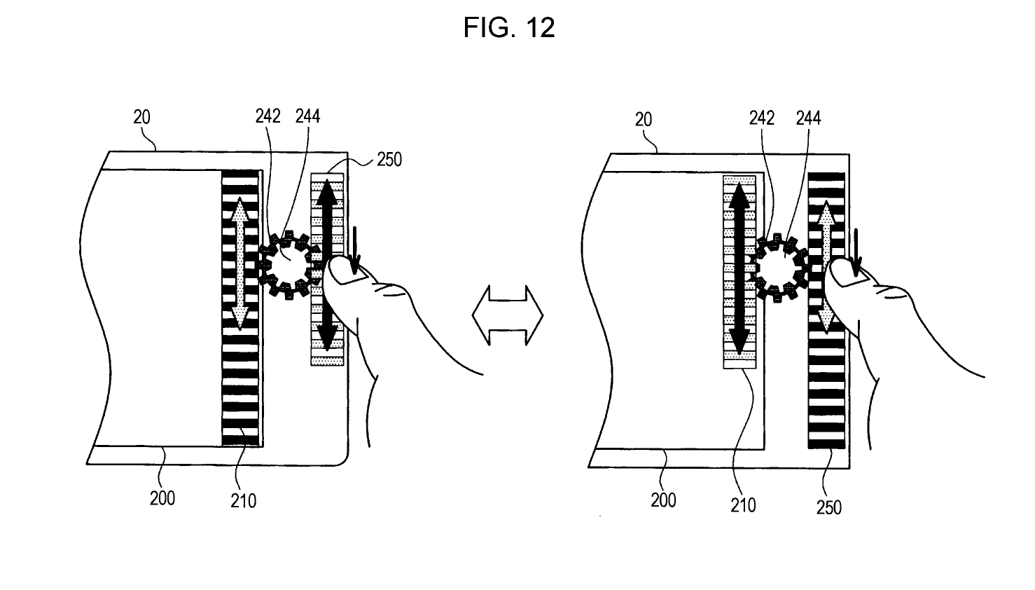

Next, an example of display of auxiliary information by an information processing apparatus 100 according to a second embodiment of the present invention will be described. The configuration of the information processing apparatus 100 according to this embodiment is substantially similar to that of the information processing apparatus 100 according to the first embodiment. In the first embodiment, the information processing apparatus 100 is configured to display two intersecting rack gear graphics 210 and 220 as auxiliary information. In this embodiment, in contrast, a wheel graphic is displayed as auxiliary information. Using a wheel graphic as auxiliary information enables the representation of the movement speed of display information in addition to the movement direction of the display information. Hereinafter, display control of auxiliary information by the information processing apparatus 100 according to this embodiment will be described in detail with reference to FIGS. 11 and 12. FIG. 11 is a diagram illustrating an example of a wheel graphic displayed as auxiliary information. FIG. 12 is a diagram illustrating an example of display of auxiliary information indicating the movement speed of the content 200 using the function of a variable speed gear.

Example of Display of Auxiliary Information with Use of Rotary Operation Unit

The information processing apparatus 100 according to this embodiment may be implemented using, for example, as illustrated in FIG. 11, an apparatus including an operation unit 40 of the dial type that is rotated with the finger, or an apparatus including an operation area where the rotational direction of the finger can be detected. In this case, a wheel graphic 240 indicating the rotational direction is displayed. The graphic 240 indicates the movement direction of a member that is moved directly in accordance with the movement of the finger. When the content 200, which is display information displayed on the display 20, is linearly moved by operating the member, the display control unit 120 displays auxiliary information for allowing the user to easily understand the movement direction of the content 200.

For example, in accordance with the rotation of the operation unit 40 illustrated in FIG. 11, the content 200 may be moved in the up-down direction and the right-left direction. In a case where the content 200 can be moved in the up-down direction through the operation of the operation unit 40, as illustrated in FIG. 11, a rack gear graphic 210 extending in the up-down direction, which is the movement direction of the content 200, is displayed so as to mesh with the wheel graphic 240.

When the user rotates the operation unit 40 clockwise, the content 200 is moved in the upward direction using the display control unit 120. In this case, the graphic 240 is displayed so as to rotate in accordance with the rotation of the operation unit 40. Then, the rack gear graphic 210 displayed so that the teeth of the rack gear graphic 210 mesh with the teeth of the wheel graphic 240 is displayed so as to move in the upward direction in association with the movement of the graphic 240. That is, displaying auxiliary information in which the rotating movement of the operation unit 40 is converted into the movement of the display information in the up-down direction allows a user to perform a comfortable operation even if the user moves their finger in a direction different from the movement direction of the content 200.

If the user rotates the operation unit 40 counterclockwise, the display control unit 120 causes the content 200 to move in the downward direction. In this case, the display control unit 120 displays the wheel graphic 240 so as to rotate counterclockwise, and also displays the rack gear graphic 210 to move in the downward direction.

Further, when the user wishes to move the content 200 in the right-left direction, the user may switch the movement direction of the content 200 by performing a predetermined operation, for example, pushing the operation unit 40 to inside the information processing apparatus 100. When the movement direction of the content 200 is switched, the display control unit 120 displays, as auxiliary information, a wheel graphic 240 and a rack gear graphic extending substantially parallel to the movement direction of the content 200 and having teeth that mesh with the teeth of the wheel graphic 240. Thus, even if the movement direction of the content 200 is changed, the association between the movement of the operation unit 40 operated with the finger and the movement direction of the content 200 can be represented. Also in a case where the content 200 is movable in directions other than the up-down direction and the right-left direction, auxiliary information may be displayed in a similar manner in accordance with the movement direction of the content 200.

### Presentation of Movement Speed of Content Using Function of Variable Speed Gear

The use of a wheel graphic and a rack gear graphic as auxiliary information allows the presentation of the conversion of movement in a rotational direction into movement in a linear direction, and also allows the representation of the movement speed of the content 200 with respect to the movement speed of the finger by changing the gear ratio of the wheel. For example, the representation of auxiliary information using a variable speed gear as illustrated in FIG. 12 is conceivable. A variable speed gear is a mechanism having wheels different numbers of teeth that mesh with each other in which the ratio of the angle of rotation of one of the wheels to that of the other is changed. Changing the ratio makes it possible to change the movement speed of an object to be driven by each of the wheels.

FIG. 12 illustrates the rack gear graphic 210 displayed so as to move in the movement direction of the content 200, and a rack gear graphic 250 that moves in accordance with the movement speed of the user's finger. A variable speed gear graphic including a first gear 242 and a second gear 244 that have the same rotational axis is displayed. The first gear 242 has a diameter larger than the second gear 244, and one of the first gear 242 and the second gear 244 rotates in association with the rotation of the other. Thus, the amount of movement and the movement speed of the object driven by the first gear 242 are greater than those of the object driven by the second gear 244.

In the example illustrated in FIG. 12, it is assumed that the first gear 242 and the second gear 244 rotate in the same direction. However, embodiments of the present invention are not limited to the above example, and the first gear 242 and the second gear 244 may rotate in opposite directions. That is, as the finger moves in the downward direction, the gear that meshes with the graphic 250 rotates clockwise while the gear that meshes with the graphic 210 rotates counterclockwise. Thus, the graphics 210 and 250 can be displayed so as to move in the same direction.

For example, as illustrated in the left screen in FIG. 12, it is assumed that the graphic 210 corresponding to the movement direction of the content 200 is driven by the first gear 242 and that the graphic 250 corresponding to the movement direction of the finger is driven by the second gear 244. In this case, the amount of movement of the content 200 is larger than the amount of movement of the finger. In contrast, as illustrated in the right screen in FIG. 12, it is assumed that the graphic 210 corresponding to the movement direction of the content 200 is driven by the second gear 244 and that the graphic 250 corresponding to the movement direction of the finger is driven by the first gear 242. In this case, the amount of movement of the content 200 is smaller than the amount of movement of the finger.

With the use of the characteristics of the variable speed gear, the amount of movement of the content 200 with respect to the amount of movement of finger is corresponded with the graphic 210 corresponding to the movement direction of the content 200 and the graphic 250 corresponding to the movement direction of the finger through a variable speed gear graphic. Thus, the user can visually recognize the movement direction of the finger and the movement direction of the content 200, and can also visually recognize the amount of movement of the content 200 with respect to the amount of movement of the finger.

Here, examples of the operation of changing the movement speed of the content 200 include changing the movement speed of the content 200 in accordance with pressure force applied to the operation area with the operating member that is operated to move the content 200. In this case, for example, if the finger is moved with the operation area strongly pressed, the movement speed of the content 200 is reduced to allow fine adjustment of the display range of the content 200. If the finger is moved with the operation area slightly pressed, the movement speed of the content 200 is increased to allow rough movement of the content 200. The movement speed of the content 200 may be changed stepwise each time the pressure force applied to the operation area exceeds (or drops below) a set pressure threshold value, or may be changed successively in accordance with the magnitude of the pressure force.

In the information processing apparatus 100 according to this embodiment, when the operating member is moved within the operation area to move the display range of the content 200, a wheel graphic is changed in accordance with the magnitude of pressure detected by the pressure detection unit 114, and a visual representation of the correspondence between the movement speed of the finger and the movement speed of the content 200 is presented as auxiliary information. The visual representation allows the user to visually recognize the movement direction and the movement speed of the operating member and the movement direction and the movement speed of the content 200. Therefore, operability can be improved.

In this embodiment, wheel graphics have the same rotational axis. However, embodiments of the present invention are not limited to the above example, and wheel graphics may be displayed in other manners. For example, a plurality of different wheel graphics in which adjacent wheels mesh each other may be displayed so that a wheel graphic located at an end meshes with a rack gear graphic.

### Third Embodiment

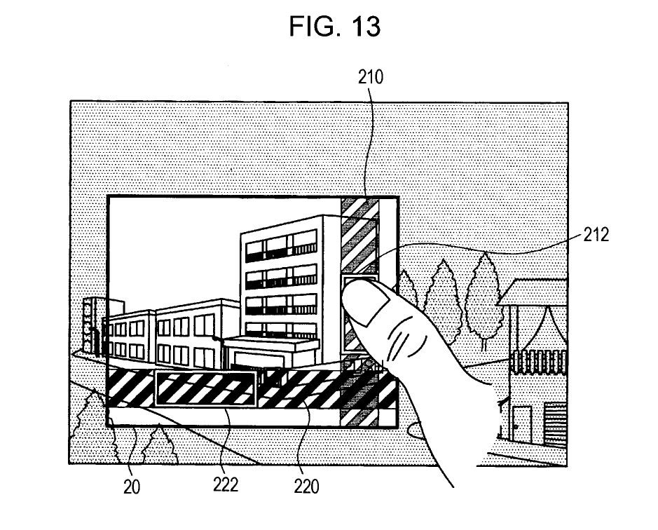

Next, an example of display of auxiliary information according to a third embodiment of the present invention will be described with reference to FIG. 13. The configuration of an information processing apparatus 100 according to this embodiment is substantially similar to that of the information processing apparatus 100 according to the first embodiment. In the first embodiment, the information processing apparatus 100 is configured to display two intersecting rack gear graphics 210 and 220 as auxiliary information. In this embodiment, in contrast, auxiliary information indicating the display range of the content 200 is further displayed in addition to the graphics 210 and 220.

As described with respect to the first embodiment, if the overall size of the content 200 is larger than the display 20 of the display unit 116, the content 200 is movable. A user can move the content 200 in a desired direction by moving their finger within the operation area. In this case, the information processing apparatus 100 according to this embodiment displays auxiliary information indicating the association between the movement direction of the operating member and the movement direction of the content 200, and also displays auxiliary information indicating the current display range with respect to the overall size of the content 200.

For example, as illustrated in FIG. 13, it is assumed that the overall size of the content 200 is larger than the display area of the display 20. In the content 200, a hatched area is an area that is not displayed in the display 20. A user can move the content 200 up, down, right, or left by moving their finger within the operation area. In this case, the display control unit 120 of the information processing apparatus 100 according to this embodiment displays, on the graphics 210 and 220 displayed as auxiliary information, knobs 212 and 222, respectively, representing the ratio of the display range of the content 200 displayed within the display area to the overall size of the content 200 and the position of the content 200.

For example, as illustrated in FIG. 13, the knobs 212 and 222 may be displayed at the display positions of the content 200 displayed within the display area with respect to the overall size of the content 200 as rectangular frames corresponding to the ratio of the display range of the content 200 displayed within the display area to the overall size of the content 200. The display of the knobs 212 and 222 allows a user to move the content 200 while recognizing at which position in the overall size the display range of the content 200 that the user is currently viewing is located. The manner in which the knobs 212 and 222 are displayed, such as the shape or color, is not limited to that in the above example.

### Fourth Embodiment

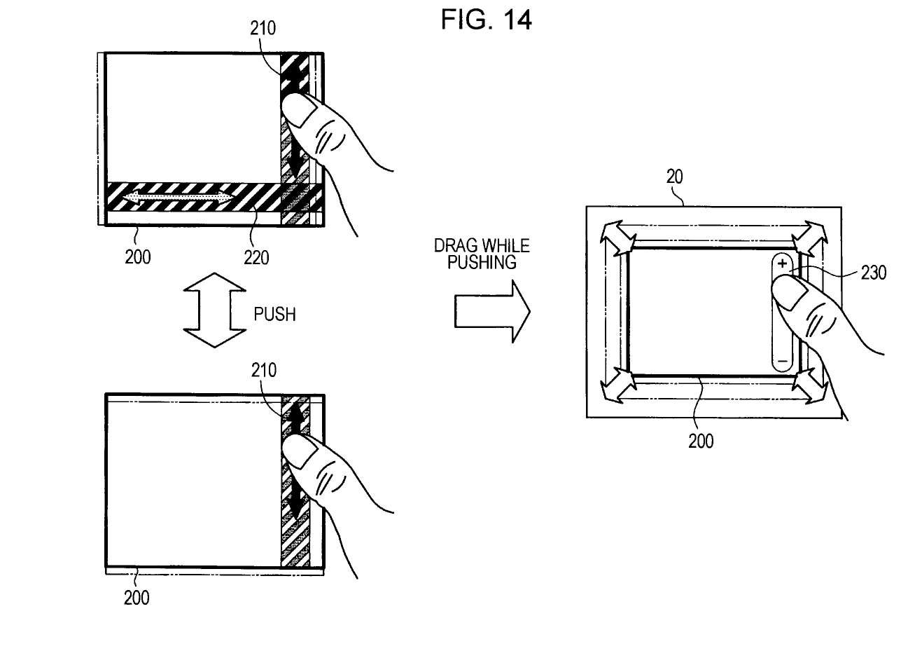

Next, an example of display of auxiliary information according to a fourth embodiment of the present invention will be described with reference to FIG. 14. The configuration of an information processing apparatus 100 according to this embodiment is also substantially similar to that of the information processing apparatus 100 according to the first embodiment. The information processing apparatus 100 is configured to, in addition to moving the content 200 in a plurality of directions by inputting operation information about only one direction, which has been described in the first embodiment, enlarge or reduce the content 200. Hereinafter, a process for enlarging or reducing the content 200 using the information processing apparatus 100 according to this embodiment will be described in detail.

As illustrated in the two left screens in FIG. 14, as in the first embodiment, the information processing apparatus 100 according to this embodiment is configured such that the movement direction of the content 200 can be switched by, for example, pushing (clicking on) the operation area. Here, when the user further performs a predetermined operation to switch the current operation mode to an enlargement/reduction mode in which the content 200 can be enlarged or reduced, the current operation mode is switched from a movement mode in which the display range of the content 200 is moved to the enlargement/reduction mode. Examples of the operation of switching the current operation mode to the enlargement/reduction mode may include moving a finger while pushing the operation area.

When the enlargement/reduction mode is set, the auxiliary information indicating the association between the movement direction of the finger and the movement direction of the content 200 is brought into a non-display state. Then, as illustrated in the right screen in FIG. 14, a scale 230 for adjusting the display magnification of the content 200 is displayed. A user can display the content 200 at a desired magnification by moving their finger along the scale 230. Moving a finger in the direction in which the display magnification increases enlarges the display of the content 200, and moving a finger in the direction in which the display magnification decreases reduces the display of the content 200. If the finger is released from the operation area, the enlargement/reduction mode ends. At this time, the content 200 may be displayed at the display magnification obtained at the end of the enlargement/reduction mode, or may be displayed at a preset basic magnification.

Therefore, with the use of the information processing apparatus 100 according to this embodiment, a user can perform a variety of processes even when the user is allowed to input operation information only in one direction.

Example of Application of Display Process according to First to Fourth Embodiments

The display control process performed by the information processing apparatus 100, as described above with respect to the first to fourth embodiments, can be applied not only to an operation for an image displayed on the display 20 of the image capture apparatus 1 but also to an operation of any other tool such as a web browser or a map viewer. The operation described above can be performed if the operation area is small, which is effective particularly in a small mobile terminal.

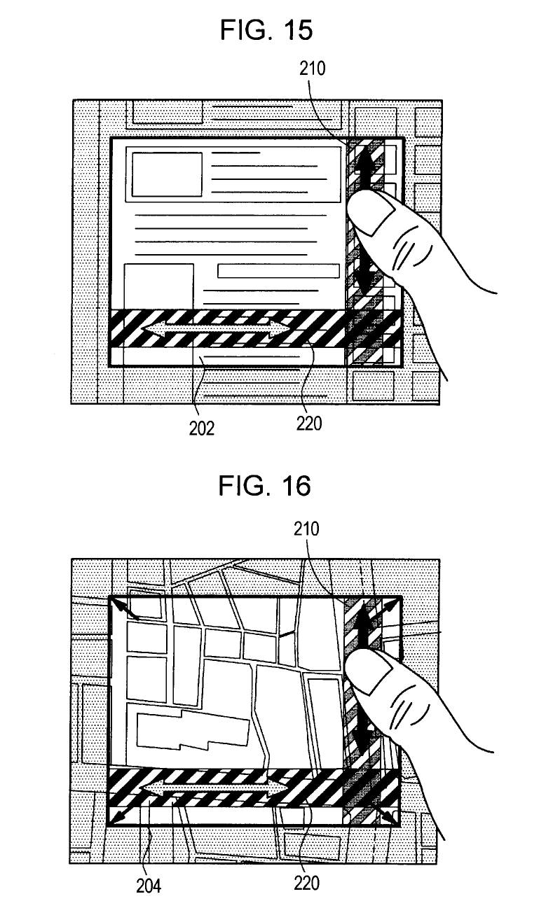

For example, FIG. 15 illustrates an example in which the display control process performed by the information processing apparatus 100 according to the first embodiment described above is applied to the operation of a web browser 202. When the display area of a display is larger than the overall size of the web browser 202, a portion of the web browser 202 is displayed in the display area.

For example, if an operation area for inputting operation information for moving the display range of the web browser 202 can be detected only in one direction (for example, up-down direction, as viewed in FIG. 15), as illustrated in FIG. 9, the gear graphics 210 and 220 are displayed as auxiliary information. Thus, even if the limitation of space causes a user to move their finger in the up-down direction in order to move the web browser 202 up, down, right, or left, operability can be improved by displaying auxiliary information indicating the association between the movement direction of the finger and the movement direction of the web browser 202. In addition, as in the third embodiment, auxiliary information indicating the current display range with respect to the overall size of the web browser 202 may further be displayed.

Further, FIG. 16 illustrates an example in which the display control process performed by the information processing apparatus 100 according to the fourth embodiment described above is applied to the operation of a map viewer 204. Also in this case, when a user is caused to move their finger in the up-down direction in order to move the map viewer 204 up, down, right, or left in a manner similar to that in the case where the display range of the web browser 202 is moved, the gear graphics 210 and 220 are displayed as auxiliary information. Further, as illustrated in FIG. 14, the operation mode may be switched to the enlargement/reduction mode so that a map displayed in the map viewer 204 can be enlarged or reduced. Therefore, the operability of the map viewer 204 can further be improved.

### Fifth Embodiment

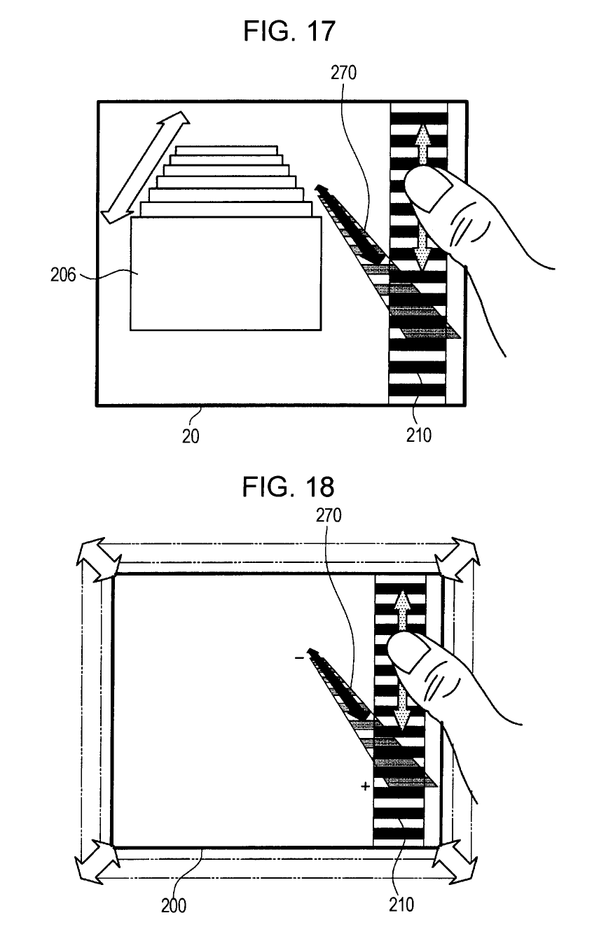

Next, an example of display of auxiliary information according to a fifth embodiment of the present invention will be described with reference to FIGS. 17 and 18. The configuration of an information processing apparatus 100 according to this embodiment is also substantially similar to that of the information processing apparatus 100 according to the first embodiment. In the first embodiment, the movement of the display information in the plan-view direction of the display 20 has been described in easily understandable form using auxiliary information. In this embodiment, the movement in the depth direction is also presented using auxiliary information.

For example, as illustrated in FIG. 17, it is assumed that a content list in which a plurality of content items 206 are arranged in the depth direction is displayed in the display area of the display 20. In this case, the display control unit 120 displays a gear graphic 270 extending in a direction in which the content items 206 are arranged in such a manner that the gear graphic 270 meshes with the gear graphic 210 displayed in a direction substantially parallel to the movement direction of the finger within the operation area.

A user can perform an operation of moving the content items 206 in the content list forward or backward by moving their finger within the operation area. In this case, the graphic 210 is displayed so as to move in accordance with the movement direction of the finger, and the graphic 270 is displayed so as to move in association with the movement of the graphic 210. The provision of the auxiliary information whose linear movement within the operation area is converted into the depth direction allows a user to visually recognize the association between the movement of the finger and the movement direction of the objected that is operated in accordance with the movement of the finger and to easily perform an operation.

Furthermore, as illustrated in FIG. 18, the display magnification of the display information may be represented with the gear graphic 270 extending in the depth direction. For example, the graphic 270 may be configured such that the farther away the graphic 270 is from the viewer, the smaller the size of the display information, and the closer the graphic 270 is to the viewer, the more the display information is enlarged. In this case, the graphic 210 moves in accordance with the movement of the finger within the operation area, and the graphic 270 moves in association with the movement of the graphic 210. A user can recognize the display magnification of the display information based on the intersection position of the graphics 210 and 270 with respect to the overall length of the graphic 270. In this manner, increased visibility of display information being displayed can improve operability.

The configuration of the information processing apparatus 100 according to the first to fifth embodiments of the present invention, and a process for controlling the display of display information and auxiliary information using the information processing apparatus 100 have been described. The information processing apparatus 100 according to the illustrated embodiments is configured to display auxiliary information indicating the movement direction of an operating member for moving display information and also indicating the movement direction of the display information. The auxiliary information may be a graphical representation of a mechanism for physical conversion of the direction of movement, and may give a user a visual presentation of the association between the movement direction of the operating member and the movement direction of the display information in easily understandable form. Thus, operability can be improved. Further, the display of auxiliary information using the characteristics of a variable speed gear also gives a presentation of the association between the amount of movement of the operating member and the amount of movement of the display information in accordance with the movement of the operating member.

While exemplary embodiments of the present invention have been described in detail with reference to the accompanying drawings, embodiments of the present invention are not limited to the above embodiments. It is to be understood that a person having ordinary knowledge in the art can easily contemplate various changes or modifications without departing from the technical spirit described in the appended claims, and such changes or modifications may also fall within the technical scope of the present invention.

The present application contains subject matter related to that disclosed in Japanese Priority Patent Application JP 2009-261283 filed in the Japan Patent Office on Nov. 16, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a detection unit configured to detect an operation input in a predetermined operation direction; and
a display control unit configured to display, on a display unit, first auxiliary information indicating the predetermined operation direction, and second auxiliary information indicating a movement direction of display information with respect to the display unit, and to move the display information while moving the first auxiliary information in the movement direction in accordance with the operation input detected by the detection unit and moving the second auxiliary information in association with the movement of the first auxiliary information.

2. The information processing apparatus according to claim 1, wherein the display information is movable in a plurality of directions with respect to the display unit, and
wherein the display control unit is configured to change the movement direction of the display information and an indication of the second auxiliary information indicating the movement direction of the display information, in accordance with a pressing operation input detected by the detection unit.

3. The information processing apparatus according to claim 1, wherein when the detection unit detects a pressing operation input and a moving operation input, the display control unit is configured to enlarge or reduce the display information in accordance with a magnitude of the pressing operation input detected by the detection unit.

4. The information processing apparatus according to claim 1, wherein when the detection unit detects a pressing operation input and a moving operation input, the display control unit is configured to move the display information in a depth direction in accordance with a magnitude of the pressing operation input detected by the detection unit, and to display second auxiliary information indicating the depth direction.

5. The information processing apparatus according to claim 1, wherein the display control unit is configured to change an amount of movement of the display information in accordance with a magnitude of a pressing operation input detected by the detection unit.

6. The information processing apparatus according to claim 1, wherein each of the first auxiliary information and the second auxiliary information includes a gear graphic that is a graphical representation of a gear, and
wherein the display control unit is configured to move the display information in accordance with an operation input detected by the detection unit, and
wherein the display control unit is configured to move a first gear graphic indicating the operation direction in the operation direction, and to display a second gear graphic configured to mesh with the first gear graphic in association with the movement of the first gear graphic, the second gear graphic indicating the movement direction of the display information with respect to the display unit.

7. The information processing apparatus according to claim 6, wherein the display control unit is configured to change a gear ratio of gear graphics displayed as the first auxiliary information and the second auxiliary information, in accordance with a ratio of an amount of movement of an operating member used to perform an operation input to an amount of movement of the display information.

8. The information processing apparatus according to claim 1, wherein the display control unit is configured to display the first auxiliary information and the second auxiliary information in a peripheral area of the display unit.

9. The information processing apparatus according to claim 1, wherein the display control unit is configured to display third auxiliary information on the display unit, the third auxiliary information indicating a ratio and position of a display range displayed within a display area of the display unit to an overall size of the display information.

10. An information processing method comprising the steps of:
detecting an operation input in a predetermined operation direction;
displaying, on displaying means, first auxiliary information indicating the operation direction and second auxiliary information indicating a movement direction of display information with respect to the displaying means; and
moving the display information while moving the first auxiliary information in the movement direction in accordance with the detected operation input and moving the second auxiliary information in association with the movement of the first auxiliary information.

11. A program for causing a computer to function as an information processing apparatus comprising:
detecting means for detecting an operation input in a predetermined operation direction; and
means for displaying, on displaying means, first auxiliary information indicating the predetermined operation direction and second auxiliary information indicating a movement direction of display information with respect to the display unit, and for moving the display information while moving the first auxiliary information in the movement direction in accordance with the operation input detected by the detecting means and moving the second auxiliary information in association with the movement of the first auxiliary information.
